(19) United States
(12) Patent Application Publication
(10) Pub. No.: US 2006/0031875 A1
(43) Pub. Date: Feb. 9, 2006

(54) Apparatus and method for supplying electronic program guide for video on demand services

(75) Inventor: Kyong-yong Yu, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/197,343

(22) Filed: Aug. 5, 2005

(30) Foreign Application Priority Data
Aug. 5, 2004 (KR) 10-2004-0061722

(51) Int. Cl. H04N 7/16; H04N 5/445; G06F 13/00; G06F 3/00

(52) U.S. Cl. 725/39; 725/40; 725/5

(57) ABSTRACT

Provided are an apparatus and method for supplying electronic programs for Video On Demand (VOD) services. The apparatus includes a service data receiving unit to receive service data about an image-based service, a service data sorting unit to sort the received service data according to a predetermined sorting condition, and a control unit to display the sorted service data according to the sorting condition through a predetermined graphical user interface.

This application claims the priority from Korean Patent Application No. 10-2004-0061722 filed on Aug. 5, 2004, the disclosure of which is incorporated herein in its entirety by reference.

### BACKGROUND OF THE INVENTION

1. Field of the Invention

Apparatuses and methods consistent with the present invention relate to supplying electronic programs for Video On Demand (VOD) services. More particularly, the present invention relates to an apparatus and a system for supplying an electronic program guide for VOD services, whereby these services can be easily ascertained.

2. Description of the Related Art

Video On Demand (VOD) services refer to image-based services (e.g., movies and news) supplied through a telephone line or a cable at a service subscriber's request.

FIG. 1 illustrates a general VOD service system.

The system comprises a service supplying unit 10 to supply a service selected by the subscriber, and a service receiving unit 20 to receive the service and allow the subscriber to use service.

The service receiving unit 20 transmits the subscriber's command to the service supplying unit 10 to request a service, and the service supplying unit transmits the service requested in the command to the service receiving unit 20.

After paying a predetermined fee, the subscriber is authorized to use the received service.

As illustrated in FIG. 2, the VOD service system is operated as follows.

The subscriber selects a service among the services supplied by the service supplying unit 10 S10.

At this time, the service supplying unit 10 supplies a list of services to the service receiving unit 20, and the subscriber selects a service from the supplied service list.

The subscriber pays the predetermined fee (S20), and receives the service from the service supplying unit 10 (S30).

The VOD services are supplied in a streaming or downloading manner. With streaming, the selected service is supplied to the subscriber in real time, whereas the subscriber downloads and uses the selected service when downloading is chosen.

In the streaming service, when multiple subscribers all request an identical service, as many output channels as the number of subscribers having selected the identical service should be provided.

In the downloading service, even when multiple subscribers all request an identical service, it is not necessary to have as many output channels as the number of subscribers having selected the same service. For this reason, presently, most VOD services are supplied in the downloading manner.

However, as described above, the VOD services are simply supplied in a list by the service providing unit 10. When the subscriber downloads a service, it is difficult for the subscriber to ascertain the schedule for the service, thereby causing inconvenience to the subscriber.

Korean Unexamined Patent Publication No. 2000-0074003 discloses a method for searching for electronic program guide data and other broadcasting data for a desired date, by displaying a calendar on a TV or other displaying apparatus while receiving a broadcast. The disclosure in the '003 application enables searching for electronic program data and other broadcasting data through a calendar format associated with the broadcasting. A problem with the '003 application disclosure is that the schedule of when a service is supplied cannot be ascertained.

### SUMMARY OF THE INVENTION

An object of the present invention is to provide an apparatus and a method for supplying an electronic program guide for VOD services wherein the subscriber can easily ascertain the schedule of supplied services where he/she is supplied with VOD services to use them.

The present invention will not be limited to the above-described object, and other objects not described herein will be apparently apprehended by those in the art from the following disclosure.

According to an exemplary aspect of the present invention, there is provided an apparatus for supplying an electronic program guide for VOD services including a service data receiving unit to receive service data about an image-based service, a service data sorting unit to sort the received service data according to a predetermined sorting condition, and a control unit to display the sorted service data through a predetermined graphical user interface according to the sorting condition.

According to another exemplary aspect of the present invention, there is provided a method for supplying an electronic program guide for VOD services including receiving service data on an image-based service, sorting the received service data according to a predetermined sorting condition, and displaying the sorted service data through a predetermined graphical user interface according to the sorting condition.

### BRIEF DESCRIPTION OF THE DRAWINGS

The above and other features and advantages of the present invention will become more apparent by a detailed description of exemplary embodiments thereof with reference to the attached drawings in which:

FIG. 1 illustrates a general VOD service system;

FIG. 2 illustrates an operation of the general VOD service system;

FIG. 3 illustrates an electronic program guide for VOD services according to an exemplary embodiment of the present invention;

FIG. 4 illustrates a graphical user interface (GUI) according to a first exemplary embodiment of the present invention;

FIG. 5 illustrates the graphical user interface in which the order of enumerating a first data displayed on a cell of FIG. 4 is changed;

FIG. 6 illustrates a graphical user interface according to a second exemplary embodiment of the present invention;

FIG. 7 illustrates the graphical user interface in which an advertisement and other content are displayed in a second region of FIG. 6;

FIG. 8 illustrates a graphical user interface according to a third exemplary embodiment of the present invention;

FIG. 9 illustrates a graphical user interface according to a fourth exemplary embodiment of the present invention;

FIGS. 10 and 11 illustrate the graphical user interfaces displaying the second data on a first region of FIG. 9;

FIG. 12 illustrates a graphical user interface according to a fifth exemplary embodiment of the present invention;

FIG. 13 illustrates the graphical user interface displaying content of the advertisement on a cell selected in FIG. 12; and

FIG. 14 illustrates a method for supplying an electronic program guide for VOD services according to an exemplary embodiment of the present invention.

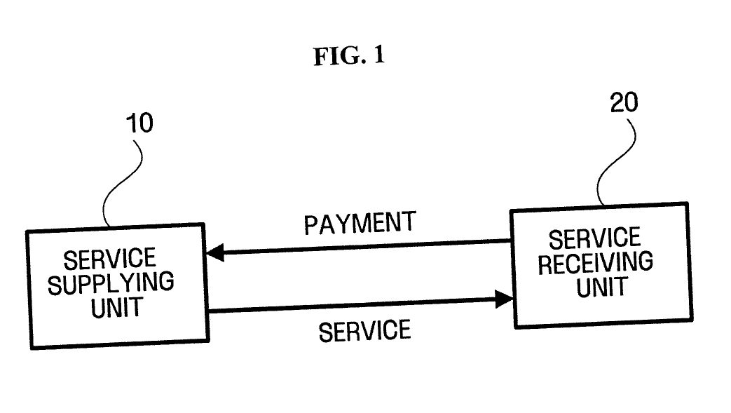

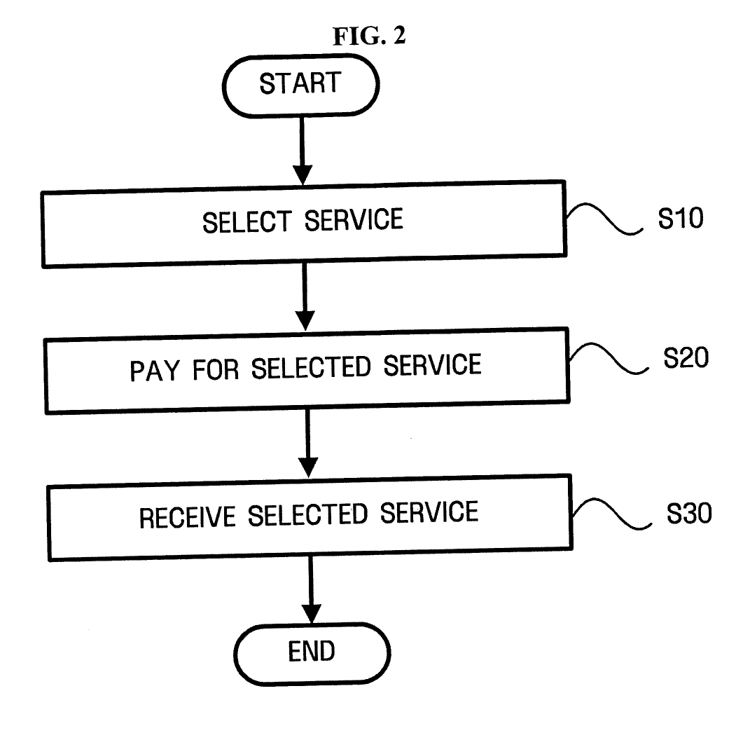

### DETAILED DESCRIPTION OF THE INVENTION

Advantages and features of the present invention and methods of accomplishing the same may be understood more readily by reference to the following detailed description of exemplary embodiments and accompanying drawings. The present invention may, however, be embodied in many different forms and should not be construed as being limited to the exemplary embodiments set forth herein. Rather, these embodiments are supplied so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described in detail with reference to the accompanying drawings.

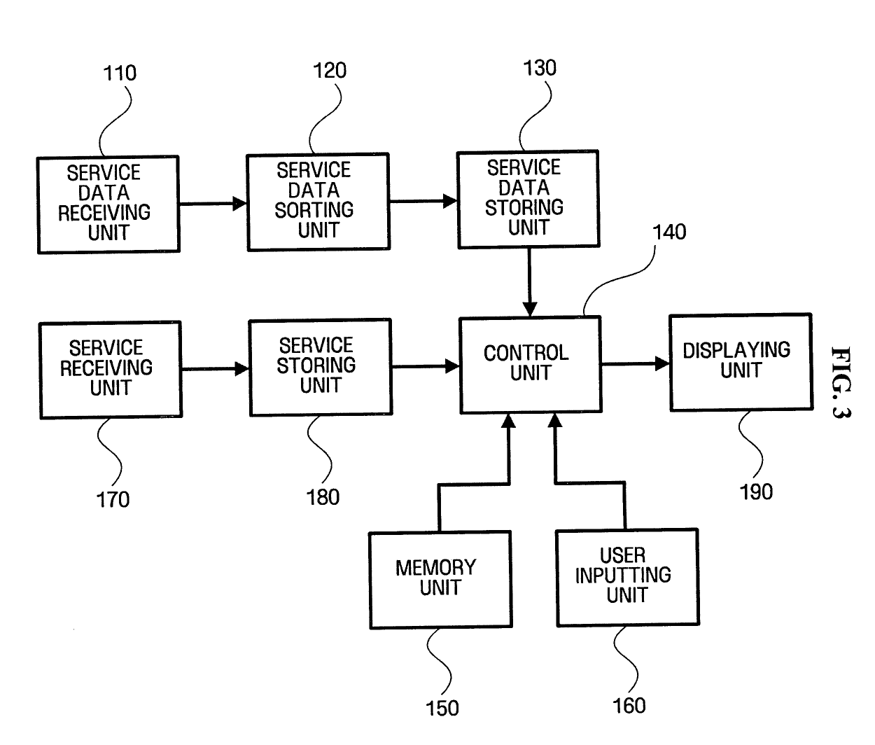

As illustrated in FIG. 3, an apparatus for supplying an electronic program guide for VOD services according to an exemplary embodiment of the present invention comprises a service data receiving unit 110 to receive data of image signal-based services, a service data sorting unit 120 to sort the received service data according to predetermined sorting conditions, a service data storing unit 130 to store the sorted service data, and a control unit 140 to display the stored service data according to specific conditions by means of a predetermined graphical user interface (GUI).

This apparatus may further comprise a memory unit 150 to store the graphical user interface, a subscriber input unit 160 through which selection values of the service data selected by the subscriber through the graphical user interface are input, a service receiving unit 170 to receive a service according to the inputted selection values, a service storing unit 180 to store the received service therein, and a display unit 190 to display the service.

The service data received through the service data receiving unit 110 may include the name of a desired service, the date when the service will be supplied, a still image of the service, and other relevant data.

When the supplied service is a movie, the relevant data may include the director, the rating of the movie, the runtime, the year of production, the country of production, the theater release date, and the dvd release date.

The service data sorting unit 120 sorts the received service data according to predetermined sorting conditions, for example, by the service delivery date.

In this exemplary embodiment, the service data sorting unit 120 sorts the received service data by date, based on the date data contained in the received service data. But, the received service data may be sorted according to various conditions based on the delivery schedule of the desired service.

The control unit 140 displays the sorted service data on the graphical user interface according to the predetermined sorting conditions.

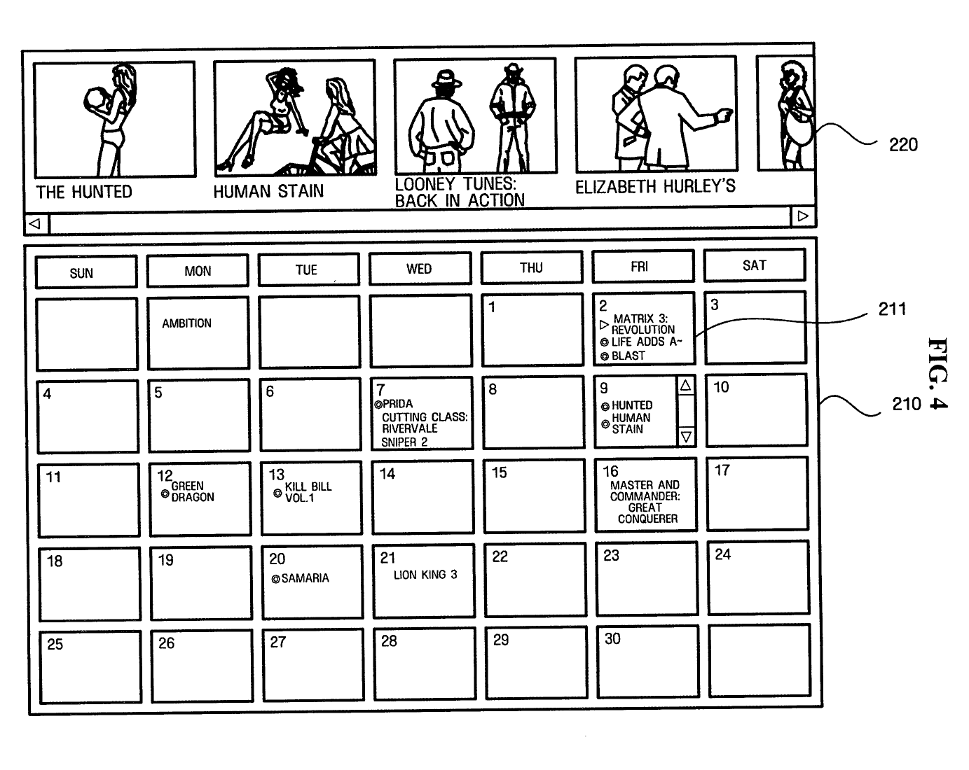

As illustrated in FIG. 4, the graphical user interface, according to a first exemplary embodiment of the present invention, comprises a first region 210, displaying first data on a desired service, and a second region 220 displaying second data linked to the first data.

In this embodiment, the first data consists of the name of the supplied desired service, and the second data consists of a name of the desired service, an image linked thereto and particular data thereof. However, the first data and the second data can be modified in some cases.

The first region 210 is a two-dimensional matrix of cells, and the first data is displayed in a cell of this matrix.

The first data displayed on the cell may be at least one data, according to the number of services supplied.

In this embodiment, the conventional x-axis represents days and the conventional y-axis represents weeks, and therefore each cell represents a particular date.

The displayed date in each cell may be a date designated in advance or a date within a predetermined period of time beginning from the date when the service is available for use, or any period of time during which the service available.

Axial labels and cell data may be received through the service data receiving unit 110. When only the date data is received, the x- and y-axes and the cells can be formed using stored forms.

Accordingly, the first data is displayed in cells corresponding to each date when the desired service is supplied, and the subscriber may select particular first data displayed in a cell and view the second data (linked to the selected first data) in the second region.

The subscriber may have to scroll to view the first data and the second data.

The subscriber input unit 160 may be comprised of a direction button and a selection button. Through the direction button, the subscriber selects a cell (in the first region 210) in which desired first data resides; this cell is highlighted and then the user selects the desired cell using the selection button.

When desired second data displayed in the second region is selected, in addition to data selected in the first region and through the subscriber input unit 160, the subscriber can highlight the desired second data using the direction button (in the same manner as the first data selection), and then select it using the selection button.

The second data may be displaced from the center of the second region 220.

The subscriber may freely use the desired service supplied by the subscriber input unit 160, or (s)he may use the service for a predetermined period of time through reservations.

When the received reservation is outside the reservation term available for using the service, the control unit 140 may add a shading to the first data of the desired service or a “Disabled” label to indicate that the reservation is not available, whereby the subscriber can easily determine whether reservations are available.

When the subscriber tries to reserve a service whose reservation term has elapsed, the control unit 140 may display a message window containing the message: “Reservation is not available”, in a pop-up format, or a similar message, as would be understood by one of skill in the art.

At this time, to ascertain states of the desired services, state data of the desired service indicating the status of the service may be added to the first data.

For example, a ‘\textcircled{0}’ symbol, when reserved by the subscriber, and a ‘ [symbol] ’ symbol, when download of the reserved service is complete, may be added to the first information as the state data.

Accordingly, the subscriber can easily ascertain whether a service is downloaded.

The number of uses of the desired service by the subscriber can also be added to the state data in the form: ‘ [symbol] ’(i.e. indicating that the service has been used once).

As such, the subscriber can easily ascertain how many times (s)he has used the desired service.

The state of the desired service may be changed through a button designated in advance by the subscriber input unit 160.

For example, reservation of the desired service can be changed through left and right direction buttons of the subscriber input unit 160.

In particular, where the current state of the desired service is reserved, the subscriber may cancel the reservation by means of the left button of the subscriber input unit 160, or (s)he may re-reserve the cancelled service by means of the right button.

The sequence of the first data displayed in a predetermined cell may be changed according to a state of the first data.

For example, the first data displayed in the predetermined cell 211 of FIG. 4 may be displayed in the sequence of the service downloaded, the service reserved, and the service neither downloaded nor reserved.

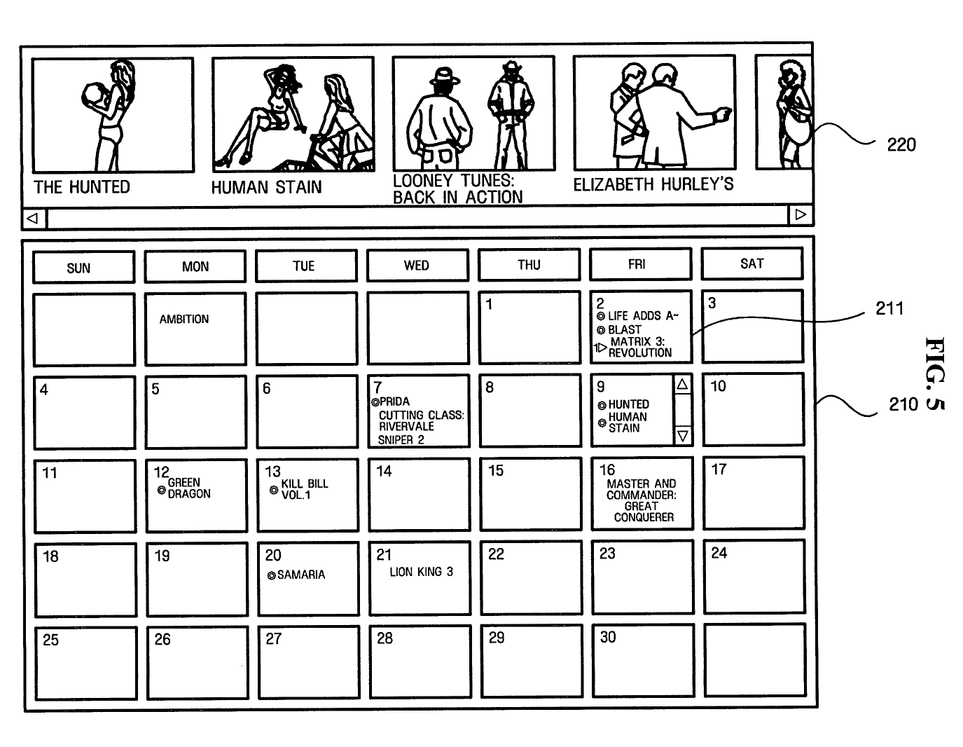

When the downloaded service is used, the service may be displayed later than the reserved service(s) in the cell 211, as depicted in FIG. 5.

When more than one downloaded service is used, they may be sequentially displayed beginning from the service less frequently used.

A service that has been used many times is less likely to be re-used by the subscriber, and thus, other services are displayed earlier.

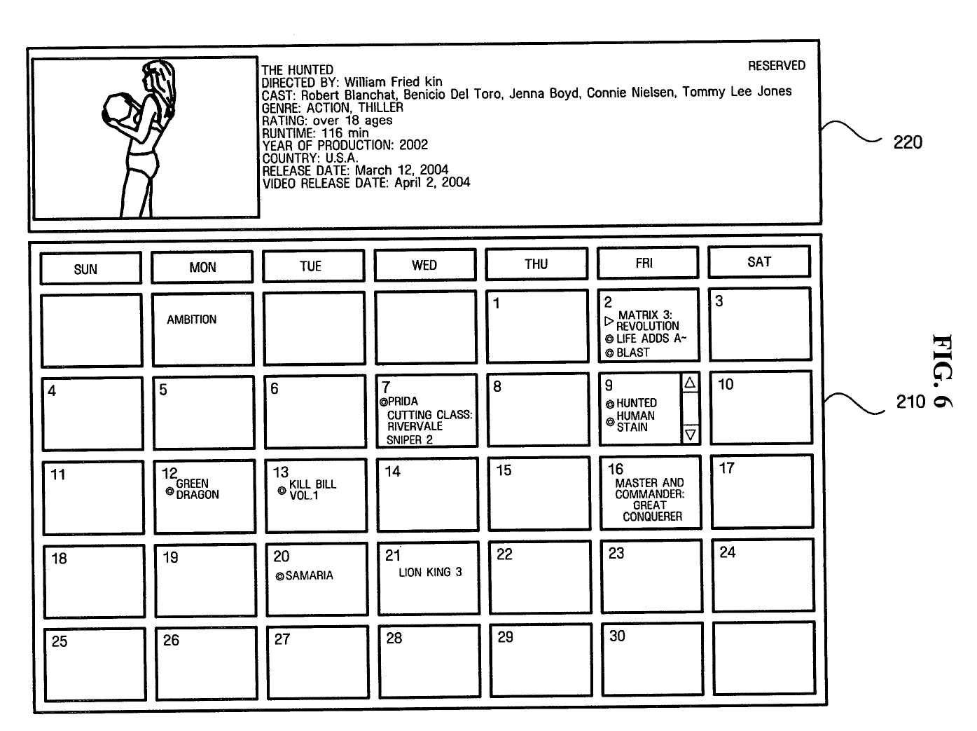

The graphical user interface according to a second exemplary embodiment of the present invention may only display the second data (selected through the first region) in the second region 220, as depicted in FIG. 6.

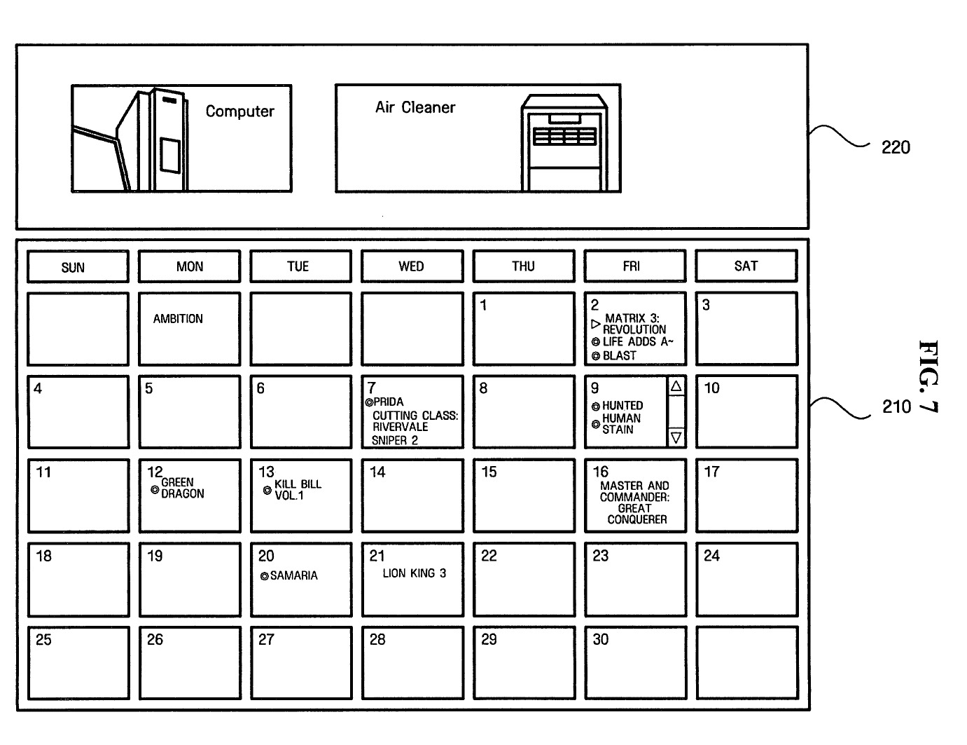

Even when the subscriber selects a cell displaying no first data, an advertisement and/or other content may be displayed in the second region 220, as depicted in FIG. 7.

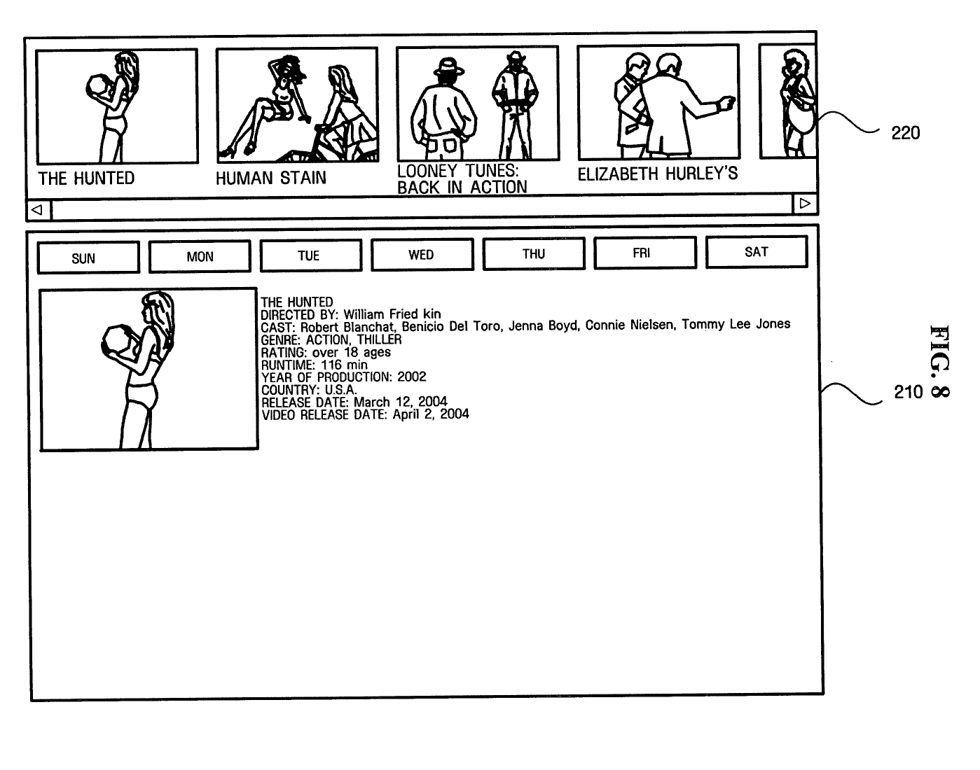

The graphical user interface according to a third exemplary embodiment of the present invention displays the second data in the first region 210, as illustrated in FIG. 8.

The second data displayed in the second region 220 can be displayed in the first region 210.

When the second data selected in the second region 220 is displayed in the first region 210, the second data displayed in the first region 210 and the second region 220 may be identical, or they may be selectively displayed.

For example, the second data displayed in the first region 210 is an image and relevant data of the desired service, and the second data displayed in the second region 220 is an image and a service name thereof.

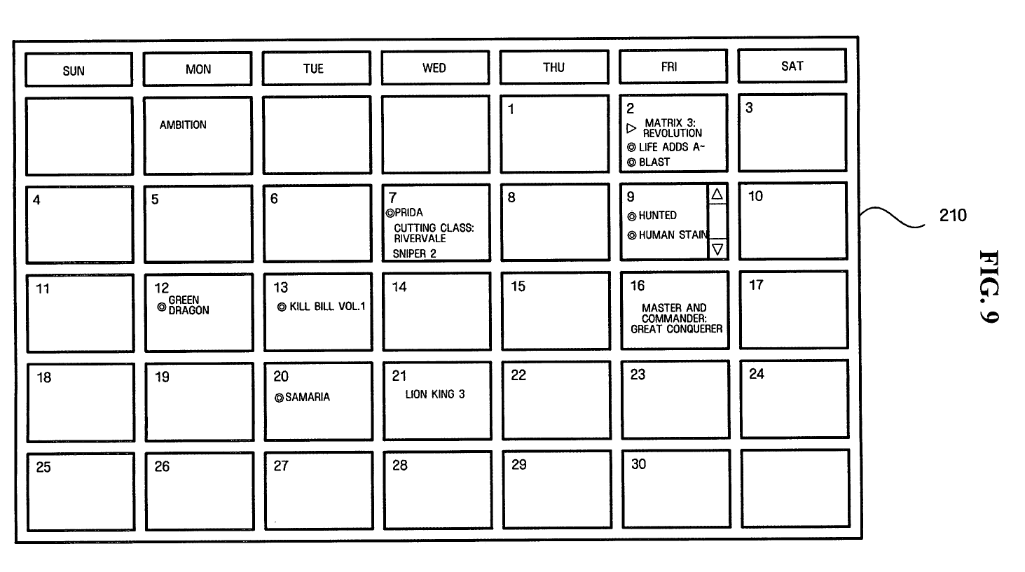

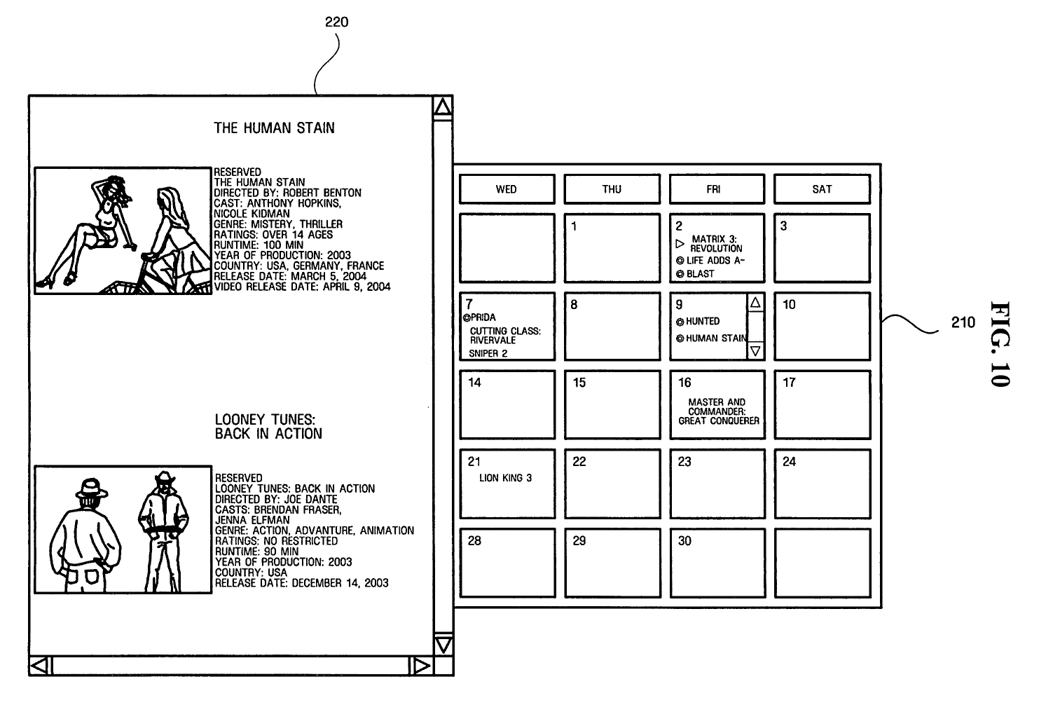

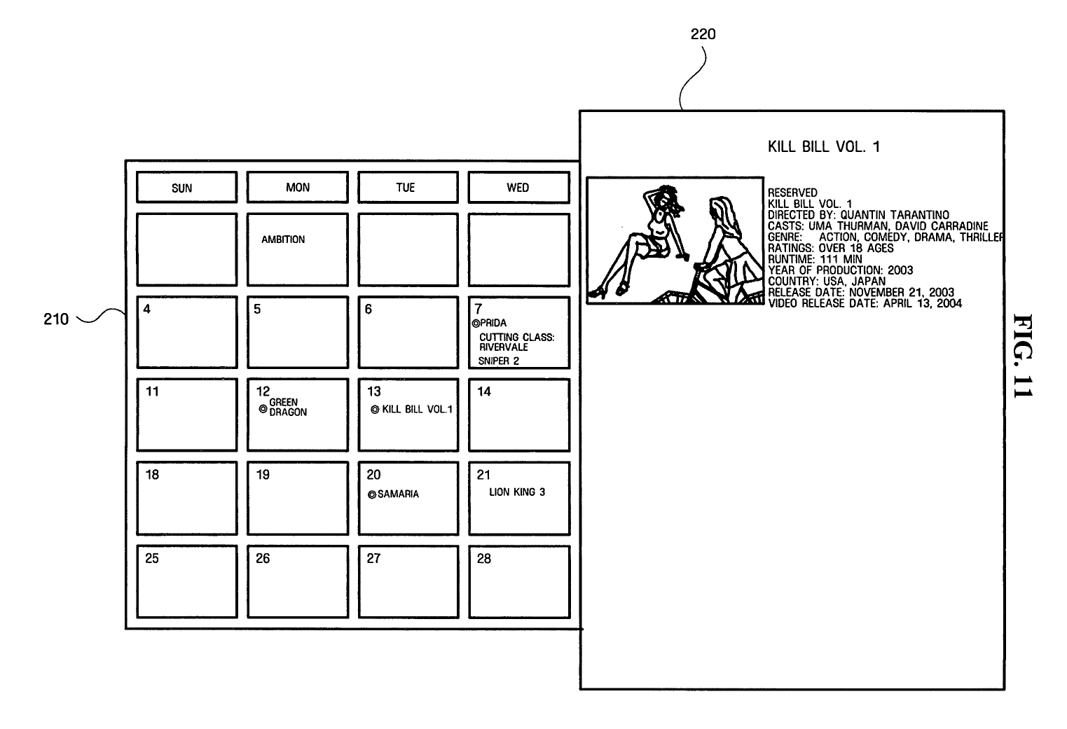

The graphical user interface according to a fourth exemplary embodiment of the present invention displays only the first region 210 at an initial stage, as depicted in FIG. 9. If the subscriber selects first data displayed in a predetermined cell through the subscriber input unit 160, the second data is overlaid and displayed on a predetermined position of the first region 210, as depicted in FIGS. 10 and 11.

When multiple data is displayed in the cell selected by the subscriber, the second data linked is displayed, and the subscriber can view the second data using a scroll bar.

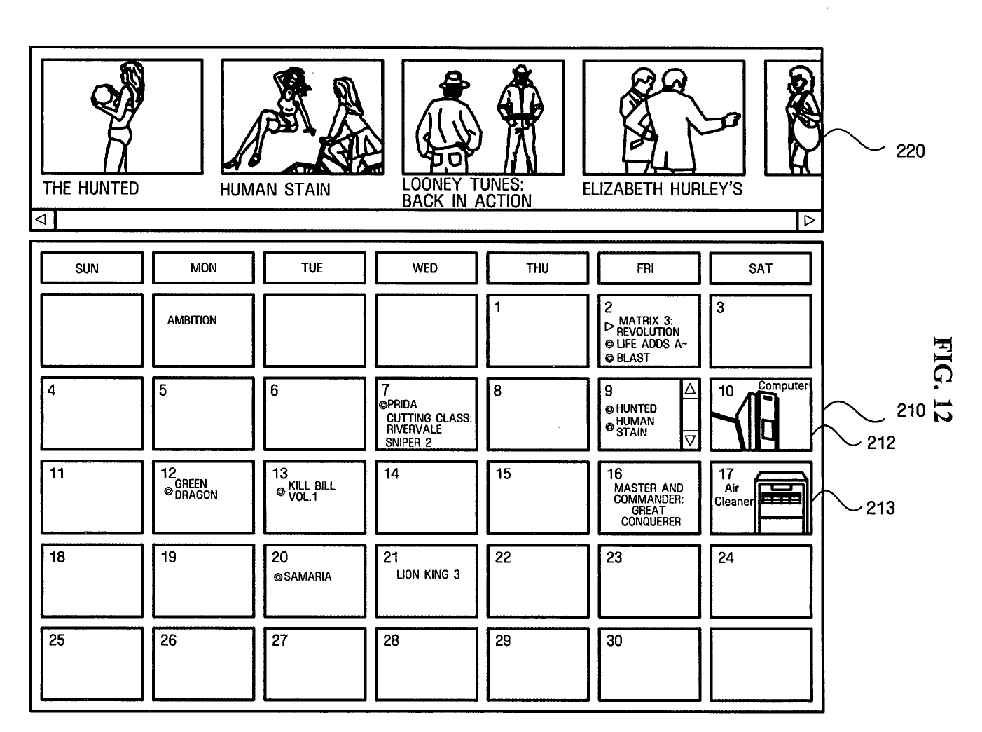

The graphical user interface according to a fifth exemplary embodiment of the present invention may separately display an advertisement and/or other content in cells 212 and 213 in the first region 210 that display no first data, as depicted in FIG. 12.

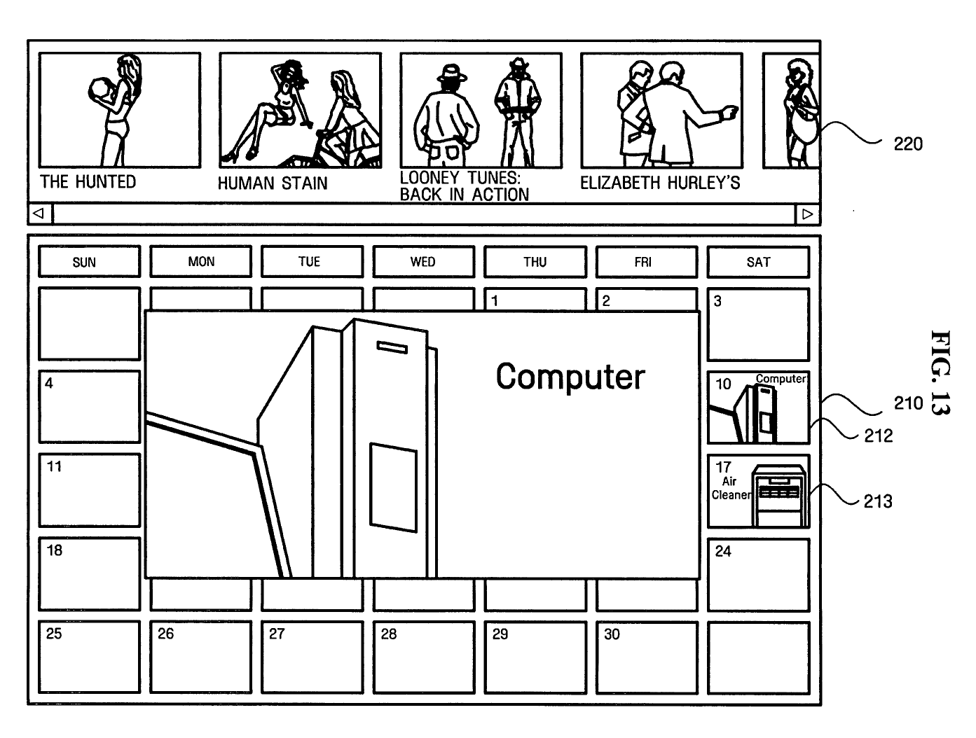

If the subscriber selects cell 212 or 213, the advertisement and/or other content in the cell is overlaid and displayed as depicted in FIG. 13.

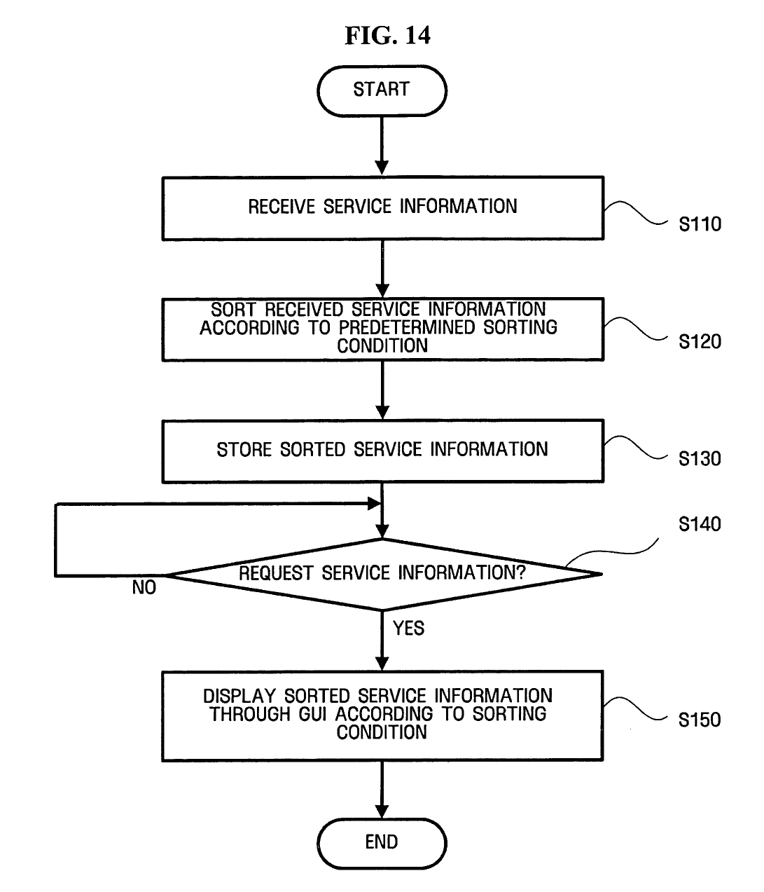

In an electronic program guide supplying method for VOD services according to an exemplary embodiment of the present invention, as depicted in FIG. 14, data regarding services supplied are received by the service data receiving unit 110 S110.

The service data may be received on a term basis, such as a predetermined period of time, or a period of time during which the service is available for subscriber.

The service data sorting unit 120 sorts the received service data according to predetermined sorting conditions S120.

In this exemplary embodiment, the service data may be sorted on a date basis, according to the date data included in the received service data.

The sorted service data is stored in the service data storing unit 130 (S130), and the control unit 140 determines whether the service data has been requested by the subscriber (S140).

As a result, if it is determined that the subscriber has requested the service data, the control unit 140 displays the service data stored in the service data storing unit 130 according to the sorting conditions and using the graphical user interface stored in the memory unit 150.

The subscriber graphical user interface used at this time may be formed as depicted in any of FIGS. 4 through 11, and the control unit 140 may determine the form of the graphical user interface in advance or randomly.

The subscriber highlights the cell in the first region 210 of the graphical user interface that displays the first data using the direction button of the subscriber input unit 160, and then (s)he can select the cell using the selection button.

The subscriber may also highlight data, among the first data displayed in the selected cell, through the direction button, and may select it using the selection button.

At this time, the second data may be displayed as in any of FIGS. 4, 6, 8, 10 and 11.

The subscriber ascertains the service that (s)he desires to view through the displayed second data, and uses the desired service in real-time or through reservations.

As described above, the present invention provides an electronic program guide supplying apparatus and method for VOD services, wherein, when a subscriber uses a VOD service, (s)he can easily ascertain the schedule for delivery of the services, and he/she can easily use a desired service.

The electronic program guide supplying apparatus and method for VOD services according to the present invention has been described with reference to the accompanying drawings. However, it will be understood by those of ordinary skill in the art that various replacements, modifications and changes in form and details may be made therein without departing from the spirit and scope of the present invention as defined by the following claims.

What is claimed is:

1. An apparatus for supplying an electronic program guide for VOD services comprising:
a service data receiving unit which receives service data about supplied services;
a service data sorting unit which sorts the received service data according to a predetermined sorting condition; and
a control unit which displays the sorted service data through a graphical user interface according to the sorting condition.

2. The apparatus of claim 1, further comprising:
a display unit to display the graphical user interface
a subscriber input unit into which a supplied service, selected by a user from the displayed service data, is inputted;
a service receiving unit which receives the selected service; and
a service storing unit which stores the received service therein.

3. The apparatus of claim 2, wherein the service data about each supplied service includes at least one of a service name, a date of data delivery, and particular data relating to the supplied service.

4. The apparatus of claim 3,
wherein the service data is divided into first data and second data, linked to the first data; and
wherein the graphical user interface includes a first region which displays the first data and a second region which displays the second data.

5. The apparatus of claim 4, wherein the first region comprises:
a first axis;
a second axis formed perpendicularly to the first axis; and
cells formed in the plane formed by the first and second axis.

6. The apparatus of claim 5, wherein the first region also displays therein a portion of the second data linked to a first data selected by a subscriber.

7. The apparatus of claim 6, wherein the second region is displayed only when the subscriber selects, in the first region, a cell in which the first data is displayed.

8. A method for supplying an electronic program guide for VOD services comprising:
receiving service data related to supplied services;
sorting the received service data according to a predetermined sorting condition; and
displaying the sorted service data through a graphical user interface according to the sorting condition.

9. The method of claim 8, wherein the service data related to each supplied service includes at least one of a service name, a data delivery date, and particular data relating to the supplied service.

10. The method of claim 9,
wherein the service data is divided into first data and second data, linked to the first data; and
wherein the graphical user interface includes a first region which displays the first data, and a second region which displays the second data.

11. The method of claim 10, wherein the first region comprises:
a first axis;
a second axis formed perpendicularly to the first axis; and
cells formed in the plane formed by the first and second axis.

12. The method of claim 11, further comprising:
highlighting a cell in which the first data is displayed in the graphical user interface;
selecting the highlighted cell; and
selecting first data displayed in the highlighted cell.

13. The method of claim 12, wherein the first region also displays therein a portion of the second data linked to a first data selected by a subscriber.

14. The method of claim 13, wherein the second region is displayed only when the subscriber selects, in the first region, a cell in which the first data is displayed.
